(19) United States
(12) Patent Application Publication
(10) Pub. No.: US 2008/0172836 A1
(43) Pub. Date: Jul. 24, 2008

(54) Positioning device for a laptop computer hinge

(75) Inventors: Chung-Yu Lee, Shulin City (TW); Jamie Horng, Shulin City (TW)

Correspondence Address: JACKSON WALKER, L.L.P., 112 E. PECAN, SUITE 2400, SAN ANTONIO, TX, 78205, US

(73) Assignee: Shin Zu Shing Co., Ltd.

(21) Appl. No.: 11/657,330

(22) Filed: Jan. 24, 2007

(51) Int. Cl. E05D 11/08

(52) U.S. Cl. 16/342

(57) ABSTRACT

A laptop computer hinge includes a pivot rod composed of a first rod and a second rod, a bracket firmly mounted on the first rod, a supporting seat mounted on the pivot rod and pivotable relative to the pivot rod, a stop mounted on the pivot rod and firmly connected to the supporting seat, a positioning block firmly mounted on the pivot rod to be adjacent to the stop, pads mounted on the second rod and a securing element securely connected to a free end of the second rod of the pivot rod to securely sandwich the pads, the positioning block and the stop with the supporting seat. A combining disk is provided on the second rod of the pivot rod and sandwiched between the pads and the positioning block to position the positioning block relative to the second rod of the pivot rod.

### BACKGROUND OF THE INVENTION

1. Field of the Invention

The present invention relates to a laptop computer hinge, and more particularly to a positioning device for a laptop computer hinge.

2. Description of the Prior Art

A hinge is to provide friction force to two objects moving in relation to one another so that one object is able to pivotally move under the influence of the friction force. The most common object that requires a hinge is a laptop computer or a PDA (personal digital assistance), etc. Taking the laptop computer for example, if the laptop computer is to be used, the user activates the locking mechanism to slightly separate the screen from the base. Then the user is able to pivot the screen relative to the base.

After use, the user is again able to pivotally move the screen toward the base to allow the locking mechanism to secure the screen to the base. During the entire pivotal movement of the screen toward the base, the hinge provides the necessary friction force to protect the screen from damage caused from impact of the screen to the base.

In order to provide such friction force, friction disks and/or spring of the hinge have to be firmly fixed to the shank of the hinge. Otherwise, the friction force is not able to support the weight of the screen of the laptop computer and the screen may just fall directly on the base of the laptop computer and the screen is damaged.

Furthermore, in order to prevent direct impact of the screen to the base, the conventional hinge needs to have a stop which is firmly fixed to the supporting seat of the hinge and a positioning block securely and firmly mounted on the shank of the hinge. When the supporting seat is pivoted relative to the shank of the hinge, engagement between the stop and the positioning block prevents direct engagement between the screen and the base of the laptop computer. That is, the positioning block needs to have no movement relative to the shank so as to provide such a feature. However, the no movement requirement of the positioning block to the shank means that the engagement precision between the positioning block and the shank is extremely high to fulfill the requirement. The current technique is to have a through hole defined in the positioning block to mate with the configuration and size of the shank. However, due to low cost consideration to the hinge parts, the positioning block is made by injection molding, which renders the precision of the positioning block hard to control. Consequently, the engagement between the positioning block and the shank is not as good as expected and the impact-proof feature can not be accomplished satisfactorily. In order to overcome the precision problem, more works and/or labor need to be involved, which evidently increases the cost.

To overcome the shortcomings, the present invention tends to provide an improved hinge to mitigate the aforementioned problems.

### SUMMARY OF THE INVENTION

The primary objective of the present invention is to provide a positioning device to the laptop computer hinge to securely lock the positioning block on the shank without any modification to the shank.

In order to accomplish the aforementioned objective, the hinge of the present invention is comprised of a pivot rod composed of a first rod and a second rod, a bracket firmly mounted on the first rod, a supporting seat mounted on the pivot rod and pivotal relative to the pivot rod, a stop mounted on the pivot rod and securely connected to the supporting seat, a positioning block mounted on the pivot rod to be adjacent to the stop, a combining disk securely mounted on the pivot rod to be securely and firmly connected to the positioning block, pads mounted on the pivot rod and a securing element to secure with a free end of the second rod of the pivot rod so as to securely sandwich the combining disk, the positioning block and the stop with the supporting seat. Due to the provision of the combining disk, precision between the positioning block and the shank is no longer required. Therefore, manufacture cost is largely reduced.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the assembled hinge of the present invention;

FIG. 2 is an exploded perspective view showing the parts of the hinge of the present invention;

FIG. 3 is an exploded perspective view showing the stop, the positioning block and the combining disk of the present invention; and

FIG. 4 is an exploded perspective view showing another embodiment of the stop, the positioning block and the combining disk of the present invention.

### DETAILED DESCRIPTION OF THE PREFERRED EMBODIMENT

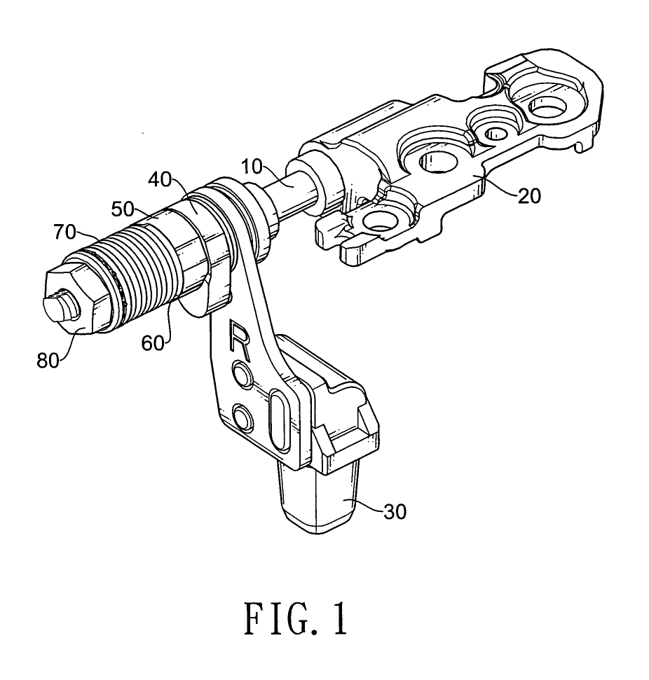

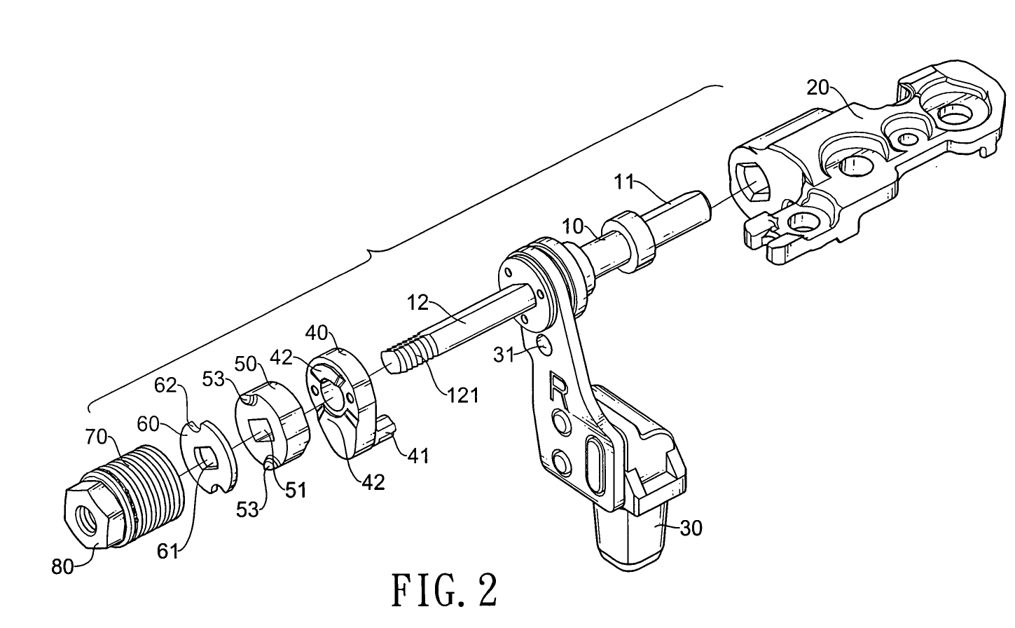

With reference to FIGS. 1 and 2, it is noted that the hinge in accordance with the present invention include pivot rod (10) composed of a first rod (11) and a second rod (12) integrally formed with the first rod (11), a bracket (20) firmly mounted on the first rod (11), a supporting seat (30) mounted on the pivot rod (10) and pivotal relative to the pivot rod (10), a stop (40) mounted on the pivot rod (10) and securely connected to the supporting seat (30), a positioning block (50) mounted on the pivot rod (10) to be adjacent to the stop (40), a combining disk (60) securely mounted on the pivot rod (10) to be securely and firmly connected to the positioning block (50), pads (70) mounted on the pivot rod (10) and a securing element (80) to secure with a free end of the second rod (12) of the pivot rod (10) so as to securely sandwich the combining disk (60), the positioning block (50) and the stop (40) with the supporting seat (30).

As stated earlier, the pivot rod (10) has the first rod (11) and the second rod (12) which is integrally formed with the first rod (11) and having threading (121) formed on a free end of the second rod (12). The bracket (20) is firmly mounted on the first rod (11) of the pivot rod (10). The supporting seat (30) is pivotally mounted on the pivot rod (10) and has a positioning hole (31) defined in a side face of the supporting seat (30).

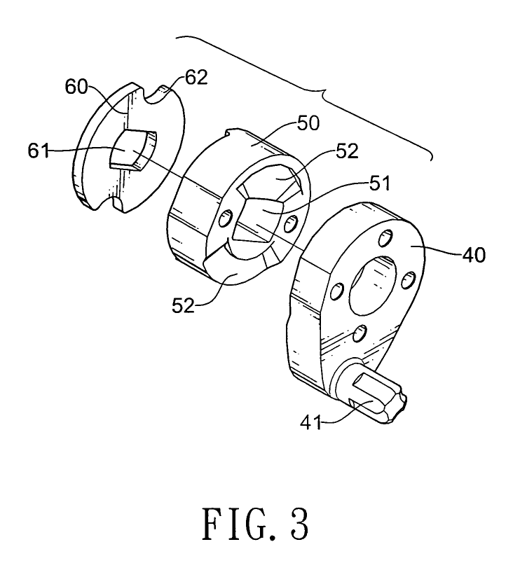

With reference to FIGS. 2 and 3, the stop (40) has a through hole (not numbered) through which the second rod (12) of the pivot rod (10) extends, an arm (41) extending lengthwise from a side face of the stop (40) to correspond to and be received in the positioning hole (31) of the supporting seat (30) and positioning protrusions (42) extending from a side face opposite to that of the arm (41) of the stop (40). The positioning block (50) has an extension hole (51) defined through the positioning block (50) and having a configuration corresponding to that of the second rod (12) of the pivot rod (10) so as to allow the second rod (12) of the pivot rod (10) to extend therethrough, positioning recesses (52) defined in a side face of the positioning block (50) to correspond to and receive therein the positioning protrusions (42) of the stop (40) and bosses (53) formed on a side face opposite to that of the positioning recesses (52) of the positioning block (50). The combining disk (60) has a stop hole (61) defined through the combining disk (60) to allow extension of the second rod (12) of the pivot rod (10) and cutouts (62) defined in a peripheral edge of the combining disk (60) to correspond to and receive therein the bosses (53) of the positioning block (50).

The pads (70) are mounted around the second rod (12) of the pivot rod (10) and the securing element (80) is a nut to be threadingly meshed with the threading (121) of the second rod (12) of the pivot rod (10).

When the hinge of the present invention is assembled, it is noted from the accompanying drawings, especially from FIGS. 1 and 2, that the stop (40) is securely connected to the supporting seat (30) because the arm (41) is extended into the positioning hole (31) of the supporting seat (30). Therefore, the stop (40) is pivoted along with the supporting seat (30) relative to the pivot rod (10). Again, because the positioning block (50) is firmly mounted on the second rod (12) of the pivot rod (10), the positioning protrusions (42) of the stop (40) are alternately received in the positioning recesses (52) of the positioning block (50). More important is that the stop hole (61) is configured in a manner that after the second rod (12) extends through the stop hole (61), there is no relative movement between the combining disk (60) and the pivot rod (10). In addition to that after the bosses (53) are received in the corresponding cutouts (62) of the combining disk (60), the combining disk (60) is immovable relative to the positioning block (50). Thereafter, the securing element, the nut, is employed to connect to the free end of the second rod (12) of the pivot rod (10) to securely sandwich the pads (70), the combining disk (60), the positioning block (50) and the stop (40) with the supporting seat (30).

Due to the provision of the combining disk (60), clearance between the positioning block (50) and the second rod (12) of the pivot rod (10) is thus allowed. Further, because the stop hole (61) is configured to mate with the configuration of the second rod (12) and the bosses (53) are received in the cutouts (62), the positioning block (50) is securely positioned on the second rod (12) of the pivot rod (10).

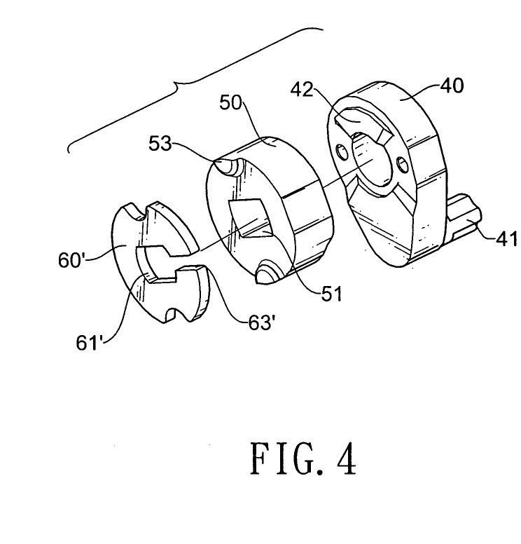

With reference to FIG. 4 and still using FIG. 2 for reference, it is noted that the combining disk (60′) has a lengthwise passage (63′) defined in communication with the stop hole (61′) such that when the second rod (12) is extended through the stop hole (61′), the provision of the lengthwise passage (63′) provides the combining disk (60) resilience to clamp the second rod (12).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a laptop computer hinge having a pivot rod composed of a first rod and a second rod integrally formed with the first rod, a bracket firmly mounted on the first rod, a supporting seat mounted on the pivot rod and pivotable relative to the pivot rod, a stop mounted on the second rod of the pivot rod and firmly connected to the supporting seat, a positioning block firmly mounted on the second rod of the pivot rod to be adjacent to the stop, pads mounted on the second rod and a securing element securely connected to a free end of the second rod of the pivot rod to securely sandwich the pads, the positioning block and the stop with the supporting seat, wherein the improvement comprises:
a combining disk is adapted to be provided on the second rod of the pivot rod and sandwiched between the pads and the positioning block to position the positioning block relative to the second rod of the pivot rod.

2. The laptop computer hinge as claimed in claim 1, wherein the combining disk has a stop hole defined through the combining disk and having a configuration corresponding to that of the second rod of the pivot rod such that after the second rod extends through the stop hole of the combining disk, there is no relative movement between the second rod and the combining disk.

3. The laptop computer hinge as claimed in claim 2, wherein the combining disk further has cutouts defined in a peripheral edge thereof to receive therein bosses adapted to be formed on a side face of the positioning block so as to maintain immovable relationship between he positioning block and the combining disk.

4. The laptop computer hinge as claimed in claim 2, wherein an arm is adapted to be formed on a side face of the stop to correspond to and be received in a positioning hole adapted to be defined in the supporting seat such that after the arm is received in the positioning hole, the stop is securely and firmly connected to the supporting seat.

5. The laptop computer hinge as claimed in claim 3, wherein an arm is adapted to be formed on a side face of the stop to correspond to and be received in a positioning hole adapted to be defined in the supporting seat such that after the arm is received in the positioning hole, the stop is securely and firmly connected to the supporting seat.

6. The laptop computer hinge as claimed in claim 4, wherein an arm is adapted to be formed on a side face of the stop to correspond to and be received in a positioning hole adapted to be defined in the supporting seat such that after the arm is received in the positioning hole, the stop is securely and firmly connected to the supporting seat.

7. The laptop computer hinge as claimed in claim 4, wherein positioning protrusions are adapted to be formed on a side face opposite to that of the arm and positioning recesses are adapted to be defined in a side face of the positioning block so that the positioning protrusions are alternately received in the positioning recesses.

8. The laptop computer hinge as claimed in claim 5, wherein positioning protrusions are adapted to be formed on a side face opposite to that of the arm and positioning recesses are adapted to be defined in a side face of the positioning block so that the positioning protrusions are alternately received in the positioning recesses.

9. The laptop computer hinge as claimed in claim 6, wherein positioning protrusions are adapted to be formed on a side face opposite to that of the arm and positioning recesses are adapted to be defined in a side face of the positioning block so that the positioning protrusions are alternately received in the positioning recesses.

10. The laptop computer hinge as claimed in claim 7, wherein the combining disk has a lengthwise passage defined in communication with the stop hole such that after the second rod is extended through the stop hole, the lengthwise passage provides resilience to clamp the second rod.

11. The laptop computer hinge as claimed in claim 8, wherein the combining disk has a lengthwise passage defined in communication with the stop hole such that after the second rod is extended through the stop hole, the lengthwise passage provides resilience to clamp the second rod.

12. The laptop computer hinge as claimed in claim 9, wherein the combining disk has a lengthwise passage defined in communication with the stop hole such that after the second rod is extended through the stop hole, the lengthwise passage provides resilience to clamp the second rod.
